(19) United States
(12) Patent Application Publication
(10) Pub. No.: US 2012/0015528 A1
(43) Pub. Date: Jan. 19, 2012

(54) CONNECTOR ASSEMBLY

(75) Inventors: CHIN-WEN YEH, Tu-Cheng (TW); YANG XIAO, Shenzhen City (CN); KAI PEI, Shenzhen City (CN)

(73) Assignees: HON HAI PRECISION INDUSTRY CO., LTD., Tu-Cheng (TW); HONG FU JIN PRECISION INDUSTRY (ShenZhen) Co., LTD, Shenzhen City (CN)

(21) Appl. No.: 12/910,667

(22) Filed: Oct. 22, 2010

(30) Foreign Application Priority Data
Jul. 15, 2010 (CN) 201010227558.5

(51) Int. Cl. H01R 12/70

(52) U.S. Cl. 439/55

(57) ABSTRACT

An apparatus includes a connector port. The connector port includes an upright portion configured to connect to a connection of a motherboard and two connection portions extending from the upright portion. An angle between the two connection portions is greater than 0 degrees and less than 180 degrees. Each of the two connection portions are configured to connect with a connector.

### BACKGROUND

1. Technical Field

The disclosure generally relates to a connector assembly, especially to a connector assembly for connecting a number of connectors.

2. Description of Related Art

Serial ATAs (SATA or Serial Advanced Technology Attachment) are computer bus interfaces for connecting host bus adapters to mass storage devices such as hard disk drives and optical drives. SATA was designed to replace the older ATA (AT Attachment) standard (also known as EIDE). SATA allows the use of the same low level commands, but SATA host-adapters and devices communicate via a high-speed serial cable over two pairs of conductors. There are SATA ports on motherboards of a PC for connecting with SATA connectors on SATA cables. As SATA connectors and SATA ports are widely used on motherboards. The SATA connectors are fixed closely together on motherboards, which makes motherboard layout difficult and the SATA connectors are difficult to be pulled out from the motherboards when needed.

Therefore there is a need for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a connector assembly with two connectors.

FIG. 2 is an assembled view of the embodiment of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

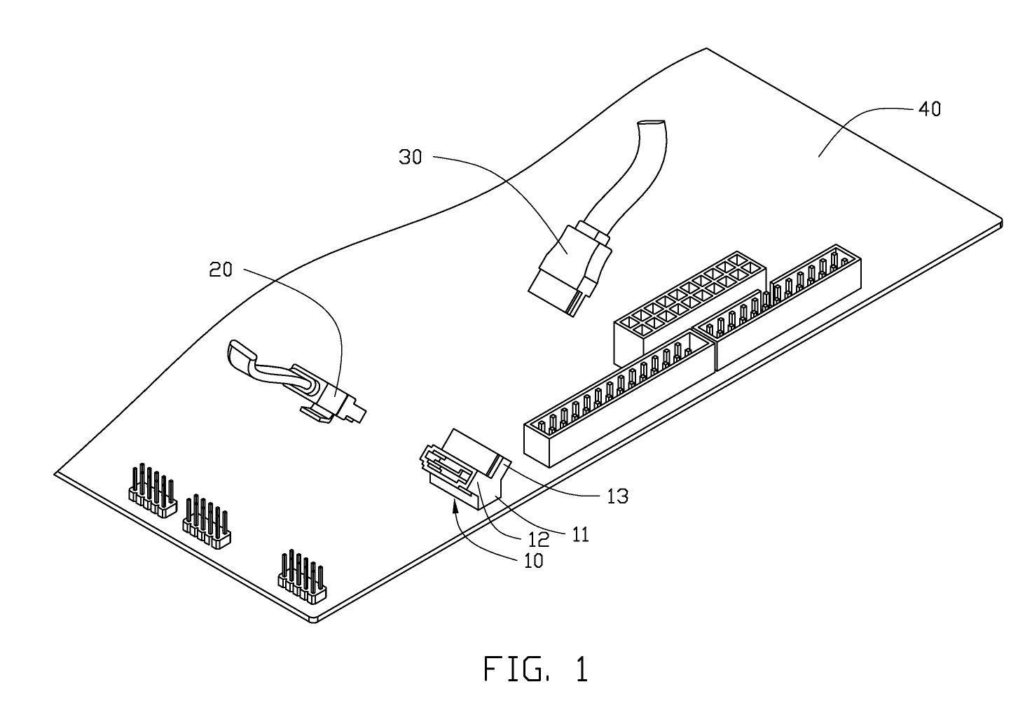

Referring to FIG. 1, a connector assembly is configured for connecting two connectors 20 and 30 with a connector port 10 on a motherboard 40. The connector port 10 includes an upright portion 11 perpendicular to the motherboard 40, and two connection portions 12, 13 extended diagonally from the upright portion 11. An angle between the connection portions 12 and 13 is greater than 0 degrees and less than 180 degrees. The upright portion 11 defines a number of metal pins (not shown) therein for electrically connecting with the connectors 20, 30. The connectors 20, 30 communicate with the motherboard 40 via the number of cables. In one embodiment, the connection portions 12 and 13 extend in different directions on a plane parallel to the motherboard 40. An angle between each of the connection portions 12, 13 and a direction perpendicular to the plane is about 45 degrees. When the angle is about 45 degrees, interference between the connection portions 12, 13 and the motherboard 40 is at a minimum, and better quality signal transmission is maintained. In one embodiment, the connectors 20 and 30 are SATA connectors. In another embodiment, the connectors 20 and 30 can also be other types of connectors, such as IDE connectors or USB connectors.

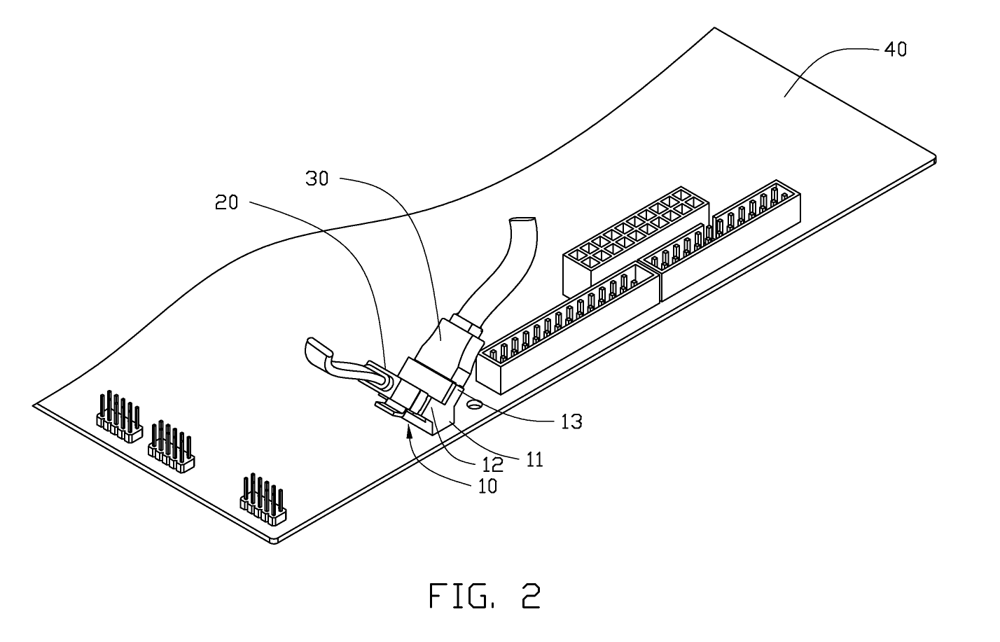

Referring to FIG. 2, in assembly, the connectors 20 and 30 are diagonally inserted in the connection portions 12 and 13. The connection portions 12, 13 define a space therebetween, making it easier to grasp and remove the connectors 20 and 30 from the connection portions 12 and 13. Because the connector assembly incorporates the connection portions 12 and 13 on a single upright portion 11, layout space on the motherboard 40 is saved.

The connector assembly is not limited to incorporating two connection portions 12 and 13 on the upright portion 11. The upright portion 11 can also define a number of connection portions thereon at regular intervals. Therefore, a number of connectors can be inserted in the connector port 10 with the number of connection portions. The intervals between the connection portions on the connector port 10 should be adequate enough to minimize electronic interference and maintain the quality of signal transmission.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A connector port for connecting to a number of connectors on a motherboard, comprising:
an upright portion fixed on the motherboard; and
two connection portions extending from the upright portion; wherein an angle between the two connection portions is greater than 0 degrees and less than 180 degrees.

2. The connector port of claim 1, wherein the two connection portions are capable of extending in different directions on a plane parallel to the motherboard.

3. The connector port of claim 2, wherein an angle between the two connection portions and a direction perpendicular to the motherboard plane is about 45 degrees.

4. The connector port of claim 1, wherein the upright portion is perpendicular to the motherboard.

5. The connector port of claim 4, wherein the upright portion defines a number of metal pins via which the two connectors are capable of communicating with the motherboard.

6. The connector port of claim 1, wherein the number of connectors are SATA connectors.

7. An apparatus comprising:
a connector port comprising:
an upright portion configured to connect to a connection of a motherboard; and
two connection portions extending from the upright portion; an angle between the two connection portions is greater than 0 degrees and less than 180 degrees;
wherein each of the two connection portions are configured to connect with a connector.

8. The apparatus of claim 7, wherein an angle between the connection portions and a direction perpendicular to the motherboard plane is about 45 degrees.

9. The apparatus of claim 7, wherein the upright portion is perpendicular to the motherboard.

10. The apparatus of claim 7, wherein the two connectors are SATA connectors.
